(19) United States
(12) Patent Application Publication
(10) Pub. No.: US 2018/0374151 A1
(43) Pub. Date: Dec. 27, 2018

(54) DYNAMIC REPUTATION SCORE FOR A DIGITAL IDENTITY

(71) Applicant: INTUIT INC., Mountain View, CA (US)

(72) Inventor: Rekha JOSHI, Mountain View, CA (US)

(21) Appl. No.: 15/634,221

(22) Filed: Jun. 27, 2017

(51) Int. Cl. G06Q 40/00

(52) U.S. Cl. CPC G06Q 40/00

(57) ABSTRACT

Techniques are disclosed for generating a reputation score of a digital identity. A reputation score of a given digital identity may be used to prevent fraud in transactions by allowing or denying a transaction based on a reputation score of the digital identities involved. The reputation score may also be used to reduce a large amount of data related to a reputation of a digital identity to a useable amount of data for real-time transaction processing. A digital identity may be created by one or more entities. A reputation score may be determined for each of the digital identities based on prior and real-time activities of the identities.

### BACKGROUND

### Field

Embodiments presented herein generally relate to techniques for determining a reputation score of a digital identity. More specifically, embodiments presented herein provide techniques for determining a dynamic reputation score of a digital identity based on historical and near real-time data related to the digital identity.

### Description of the Related Art

A reputation is an opinion about an entity (e.g., an individual or an organization) generally held by another entity. A good reputation of an entity may positively affect interactions of that entity with other entities. Similarly, a bad reputation may negatively affect interactions of the entity with other entities.

A reputation of an entity may affect business or financial related interactions of the entity. For example, an organization known to sell low-quality goods or services or misrepresent the offered goods or services may have a low reputation and likely will not get any new customers. Similarly, if an individual fails to pay invoices billed by numerous businesses, other businesses likely will not sell to or conduct other transactions with that individual.

A credit score may suggest a financial reputation of an entity. However, the credit score is limited to lines of credit opened by the entity (e.g., credit cards, charge cards, loans, etc.). Thus, the credit score does not account for day-to-day transactions or dealings of the entity that do not involve a line of credit.

For example, a business may assess a reputation of an individual before conducting a transaction with that individual. To do so, the business may obtain a credit score of the individual. However, the credit score is limited to lines of credit opened by the individual and does not allude to other business dealings of the individual. Thus, the business cannot determine an accurate reputation of the individual based solely on the credit report of the individual.

To more accurately determine a reputation of a given entity, large amounts of data may be required to be processed. This data may be related to aspects of the reputation of the entity other than financial transactions. Thus, a credit score of an entity is not sufficient to determine a reputation score that indicates an overall reputation of the entity.

### SUMMARY

One embodiment presented herein includes a computer implemented method which generally identifying at least a first digital identity and a second digital identity involved in an activity from a plurality of digital identities. The method may also include obtaining data related to prior activities of the first digital identity. The method may also include determining an initial reputation score of the first digital identity based, at least in part, one or more weighted reputation attributes. The method may also include adjusting the initial reputation score of the first digital identity based on prior activities that occurred since a previous update of the reputation score of the first digital identity. The method may also include determining whether to terminate or allow the activity based on the adjusted reputation score of the first digital identity and a reputation score of the second digital identity.

Another embodiment presented herein includes a computer-readable storage medium storing instructions, which, when executed on a processor, perform an operation which generally includes identifying at least a first digital identity and a second digital identity involved in an activity from a plurality of digital identities. The operation may also include obtaining data related to prior activities of the first digital identity. The operation may also include determining an initial reputation score of the first digital identity based, at least in part, one or more weighted reputation attributes. The operation may also include adjusting the initial reputation score of the first digital identity based on prior activities that occurred since a previous update of the reputation score of the first digital identity. The operation may also include determining whether to terminate or allow the activity based on the adjusted reputation score of the first digital identity and a reputation score of the second digital identity.

Still another embodiment presented herein includes a system having a processor and a memory hosting an application, which, when executed on the processor performs an operation which generally includes identifying at least a first digital identity and a second digital identity involved in an activity from a plurality of digital identities. The operation may also include obtaining data related to prior activities of the first digital identity. The operation may also include determining an initial reputation score of the first digital identity based, at least in part, one or more weighted reputation attributes. The operation may also include adjusting the initial reputation score of the first digital identity based on prior activities that occurred since a previous update of the reputation score of the first digital identity. The operation may also include determining whether to terminate or allow the activity based on the adjusted reputation score of the first digital identity and a reputation score of the second digital identity.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an example computing environment, according to one embodiment.

FIG. 2 illustrates a method for determining the validity of a digital identity and whether to generate a reputation score of the digital identity, according to one embodiment.

FIG. 3 illustrates a method for determining a reputation score of a digital identity, according to one embodiment.

FIG. 4 illustrates a flow diagram illustrating example operations using a dynamic reputation score in processing a transaction, according to one embodiment.

FIG. 5 illustrates an example computing system configured to generate a reputation score of a digital identity, according to one embodiment.

### DETAILED DESCRIPTION

Embodiments presented herein provide techniques for determining a reputation score of a digital identity. More specifically, embodiments presented herein provide techniques for generating and maintaining a dynamic reputation score of a digital identity and using data related to transactions performed by an entity associated with a digital entity to continually train a learning model used to generate the reputation scores for digital entities.

As discussed herein, a dynamic reputation score may be generated for a digital identity based on historical and near real-time data. However, various problems arise with real-time transaction processing due to large amounts of data related to the reputation of the digital identity are spread across multiple domains. Furthermore, the amount of data related to the reputation of the digital identity may increase over time as more activities and transactions are performed by the digital identity.

The large amount of data related to a reputation of a digital identity may inhibit real-time transaction processing when the transaction is dependent on a reputation score of an entity involved in the transaction. Thus, embodiments disclosed herein reduce the large amount of data to a useable amount of data for near real-time transaction processing.

Embodiments disclosed herein also allow a computer system to approve or deny a transaction based on a reputation score of the digital identities involved in the transaction. Denying a transaction in real-time may prevent fraud in a transaction. For example, a real-time reputation score of a non-viable digital identity may be used to prevent the non-viable digital identity from obtaining financial information related to another digital identity involved in the transaction.

A digital identity may be created and registered by an entity (e.g., an individual or a business) by providing data related to the entity such as a name, address, and other contact information. An entity may create a digital identity to track a reputation score associated with the identity and to limit the number of fraudulent transactions entered into. The digital identity may also allow access to a reputation score of other digital identities.

Each digital identity may be associated with a reputation score. An entity associated with a given digital identity may use the reputation score to monitor a level of activity of that entity and to make informed decisions regarding whether to conduct an activity with another digital identity. The reputation score may provide a single data point indicating a reputation of the associated digital identity based on a large amount of data spread across multiple domains. The reputation score may also indicate a level of confidence in the corresponding digital identity and whether the digital identity is trustworthy in doing business.

A low reputation score may indicate that the associated digital identity is not trustworthy and may not be a viable counterparty to a transaction. A high reputation score may indicate that the associated digital identity has performed many successful transactions and may be a viable counterparty to a transaction. For example, a given digital identity may use the reputation score of another digital identity to determine whether to conduct a business transaction with the other digital identity.

A reputation score of a given digital identity may also be used to automatically allow or deny a transaction from being performed. A reputation score engine may determine whether the reputation score satisfies a reputation threshold. If the reputation score satisfies the threshold, the reputation score engine may allow the transaction to be conducted. If the reputation score does not satisfy the threshold, the reputation score engine may deny or terminate the transaction, or, in some cases, forward the transaction details (e.g., an identity of the counterparty to the transaction and the data about the transaction) to an entity for review and approval.

To determine a reputation score of a digital identity in real-time, an activity monitor may obtain real-time data related to a transaction or interaction of the digital identity. The activity monitor may also obtain data related to prior transaction and interactions conducted by the digital identity. The interactions may include any activity taken by a given digital identity that involves another digital identity. For example, an interaction may include a discussion between the two digital identities. The discussion is an interaction for each of the digital identities involved.

The transactions may include any interaction that provides something of value to the digital identity. The value of the transaction may be of monetary value, or otherwise. For example, a transaction may include a business transaction between two digital identities, such as a purchase order. The purchase order may constitute a transaction for each digital identity involved in the transaction.

A reputation score engine may use the obtained interactions and transactions of a given digital identity to generate an initial reputation score for the digital identity. Upon creation, a digital identity may be assigned a neutral reputation score. That is, the initial reputation score of the digital identity may be between a maximum reputation score and a minimum reputation score.

The reputation score may be dynamically adjusted based on subsequent activities of the digital identity. For example, for each interaction conducted by the digital identity, the reputation score may be increased. Similarly, for each successful transaction performed by the digital identity, the reputation score may be increased.

To prevent artificial inflation of the reputation score, each interaction of the digital identity may be weighted based on a reputation score of other identities involved in the activity. For example, if a transaction is conducted between a given digital identity with a high reputation score and another digital identity with a lower reputation score, the reputation score of the given digital identity may be decreased based on an association with the other digital identity. Similarly, if the reputation score of the given digital identity is lower than the reputation score of the other identity, the reputation score of the given digital identity may be increased based on the association.

A reputation score of a digital identity may also be decreased based on a trend of the reputation score over time. For example, a reputation score of a digital identity may decrease over time based on a lack of activity or multiple activities with only a single other digital identity. The negative trend in the reputation score may be reinforced by a weighted value based on the magnitude of the trend.

Advantageously, embodiments disclosed herein provide techniques for reducing large amounts of data related to a reputation of a digital identity to a useable amount of data for real-time transaction processing. Embodiments disclosed herein also provide techniques to prevent fraud in transactions by dynamically determining whether to allow or deny a transaction. As discussed herein, a reputation score of a digital identity may be generated and dynamically updated based on real-time activity of the digital identity.

Aspects of the embodiments disclosed herein may be used to generate rules to train a machine learning model to generate and dynamically maintain a reputation score for each digital identity. For example, one or more rules may be used to train the machine learning model to learn a level of importance of each score adjustment to the reputation score of a given digital identity. That is, once a reputation score is generated for the given digital identity, the machine learning model may continually learn a weight to be assigned to one or more score adjustments. The weights may be used to dynamically update the reputation score of the given digital identity as an activity is conducted.

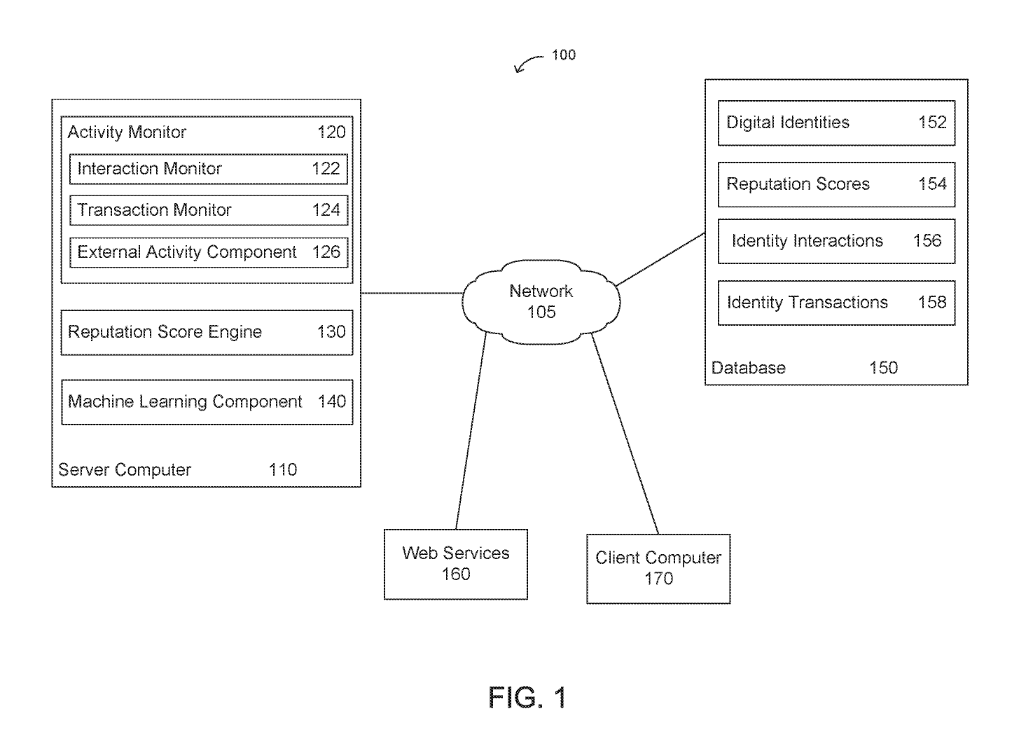

FIG. 1 illustrates an example computing environment 100, according to one embodiment. As shown, the computing environment includes a network 105, a server computer 110, a database 150, web services 160, and a client computer 170. The network 105 may be representative of a cellular network, local area network, or similar network. As illustrated, the server computer 110 includes an activity monitor 120 including an interaction monitor 122, a transaction monitor 124, and an external activity component 126, a reputation score engine 130, and a machine learning component 140.

The web services 160 may be representative of a service or an application that use a reputation score of a digital identity generated by the reputation score engine 130. For example, an entity may apply for a credit card with a financial institution. In that case, the financial institution may seek some indication of an overall reputation of the entity. The financial institution may use web services 160 to obtain a reputation score for a digital identity associated with that entity.

As shown, the database 150 includes the following data sets: digital identities 152, reputation scores 154, identity interactions 156, and identity transactions 158. The database 150 may also include a mapping between each of the data sets. Each data set may include one or more subsets of data based on a type of entity associated with the digital identities 152. For example, identity interactions 156 and identity transactions 158 may each include a subset of data for small businesses, large businesses, individuals, etc.

The digital identities 152 may include information related to a plurality of registered entities. A given entity may be an individual or a business. A client computer 170 may be used by the given entity to create and register a digital identity. A given entity may create a digital identity by providing information such as a name, address, business type, etc. Once registered, the digital identity and related information may be stored in digital identities 152.

Upon registration of a digital identity, the interaction monitor 122 may obtain all interactions in which that digital identity is involved. The interactions obtained may include completed interactions stored in identity interactions 156 or real-time interactions involving the digital identity. An interaction may include an action taken by the digital identity that involves another digital identity. For example, an interaction may include a business discussion regarding a potential purchase order between the digital identities.

Similarly, the transaction monitor 124 may obtain all transactions in which that digital identity is involved. The transactions obtained may include completed transaction stored in identity transactions 158 or real-time transactions involving the digital identity. A transaction may include any interaction that involves something valuable to the digital identities involved. The value of a transaction may be monetary or otherwise. Over time, the machine learning component 140 may learn what constitutes a value of a transaction, as discussed in more detail below.

The external activity component 126 may obtain data related to activities (i.e., interactions and transactions) of a given digital identity other than those in database 150 or obtained in real-time by the interaction monitor 122 and transaction monitor 124. The external activities may not be included in the database due to potential legal restrictions placed on the institution in possession of the data. For example, a financial institution in a foreign country may be prohibited from disclosing certain information related to a digital identity. In such a case, the external activity component 126 may obtain a financial history of the digital identity, including financial transactions involving other digital identities. Based on restrictions on the obtained data, the external activity component 126 may determine whether to store the obtained data in the respective data set in the database 150 (e.g., identity interactions 156 and identity transactions 158).

If specific data regarding the activities of cannot be obtained, the external activity component 126 may obtain an external reputation score provided by the external institution in possession of the data. In that case, the external activity component 126 may adjust the external reputation score by a weighted value indicating the reliability of the external reputation score. As an example, an external reputation score may include a credit score for a given digital identity. The external activity component 126 may assign a weight to the credit score which changes the effect of the credit score on the reputation score of that digital identity. Over time, the machine learning component 140 may learn what weighted value to use based on activities and external reputation scores obtained by the external activity component 126.

The reputation score engine 130 may assign an initial reputation score to each registered digital identity. The initial reputation score may be a neutral value that is substantially half of a difference between a maximum reputation score and a minimum reputation score. Based on subsequent interactions and transactions involving the digital identity, the reputation score engine 130 may adjust the reputation score of the digital identity.

The reputation score engine 130 may adjust the reputation score of a given digital identity based on an activity score of that identity. The activity score may represent a level of activity conducted by the digital identity since a previous update of the reputation score of that identity. For example, the activity score may be higher for each activity conducted by the given digital identity since a previous update of the reputation score of that identity. A higher activity score may have a more positive effect on the reputation score of the corresponding The higher the activity score, the more positive effect the activity score may have on the reputation score of that digital identity. The activity score may also be used to determine whether a corresponding digital identity is a viable identity.

The activity score may also represent a viability of the given digital identity. That is, the activity score may provide a direct relationship between a level of activity conducted by the given identity and how reliable that identity is in performing obligations incurred from the activities of that identity. For example, a digital identity that is active in conducting transactions with other identities may be more likely to perform the obligations incurred from a transaction based on past successful dealings with other digital identities.

To determine the activity score, the reputation score engine 130 may identify a number of other digital identities associated with an activity (e.g., an interaction or a transaction) conducted by the given identity. The reputation score engine 130 may also determine a number of other digital identities that were not associated with an activity of the given identity when the reputation score was previously updated. The reputation score engine 130 may calculate the activity score by dividing the number of other digital identities associated with an activity of the given identity by the number of other digital identities not previously associated with an activity of the given identity.

A value of each transaction conducted by a given digital identity may also affect the reputation score of that identity. The reputation score engine 130 may also determine a transaction value for a given transaction. Initially, the reputation score engine 130 may use only a monetary value of a transaction. However, over time, the reputation score engine 130 may use non-monetary value based on input from the machine learning component 140. In that case, the reputation score engine 130 may determine a subject matter of the transaction and assign a value to the transaction based on one or more completed transactions of the digital identity related to the subject matter of the transaction.

The value of each transaction conducted by the digital identity may positively affect the reputation score of that identity. This positive effect on the reputation score of an identity may encourage digital identities to conduct transactions and may promote economic growth. The effect on the reputation score may be based on a normalized transaction value.

The transaction value may be normalized by a weight of the highest transaction value performed by any digital identity divided by the highest value of a transaction conducted by the given digital identity. Using the weight to normalize the transaction value prevents a single large transaction conducted by the digital identity from artificially increasing the reputation score of that identity.

The reputation score engine 130 may also adjust the reputation score of a given digital identity based on an association with another digital identity with an established reputation score. To do so, the reputation score engine 130 may identify a reputation score for each digital identity involved in an activity (i.e., an interaction or an activity) at the time of the activity. The reputation score engine 130 may adjust the reputation score of the given digital identity based on the reputation score of the other identities. For example, when two digital identities are involved in the activity, the reputation score engine 130 may decrease the reputation score of the given identity if the other digital identities have lower reputation scores than the given identity. Similarly, the reputation score engine 130 may increase the reputation score of the given digital identity id the other identities have higher reputation scores than the given identity.

The amount of the adjustment may be based on a difference between the reputation scores. The amount of the adjustment may also be based on a weighted value of a reputation score of at least one of the other digital identities. The weight may be determined by the machine learning component 140.

The adjustment based on an association with another digital identity may be limited to successful transactions conducted between the given digital identity and at least one other digital identity. The adjustment based on an association may encourage the activities to be conducted with other digital identities with a higher reputation score. The adjustment in the reputation score may be described as a rub-off effect based on the identities involved in the current activity.

The reputation score of a given digital identity may be adjusted based on the data obtained by the external activity component 126. For example, if an external reputation score for the given identity from an external institution is lower than the current reputation score of the identity, the reputation score engine 130 may decrease the current reputation score of that identity based on a difference between the current reputation score and the external reputation score. Similarly, the reputation score engine 130 may increase the current reputation score for a higher external reputation score.

The reputation score engine 130 may identify a trend in the reputation score of a given digital identity and determine a value associated with that trend. The value associated with a negative trend in reputation score may be negative, while the value associated with a positive trend may be positive. The reputation score of the given identity may be adjusted based on the value associated with the trend.

The trend may be determined by a difference between a near real-time reputation score and an historical reputation score. The near real-time reputation score may be determined based on an average reputation score, for example, during the preceding six months. The historical reputation score may be determined based on an average reputation score, for example, during the preceding twelve months.

A time period used to generate the near real-time and historical reputation scores may change based a length of time since the corresponding digital identity was created. Further, if the difference between the near-real time and historical reputation scores exceeds a threshold, the reputation score engine 130 may change the time period. For example, if the near-real time reputation score exceeds the historical reputation score by more than 25%, the reputation score engine 130 may change the time period of the near real-time reputation score to be the preceding twelve months and change the time period for the historical reputation score to be the preceding twenty four months.

The reputation score of a given digital identity may also be affected by a completeness score. The reputation score engine 130 may determine the completeness score by identifying a number of score adjustments that have been made and a number of score adjustments that have not been made. The score adjustments made to a reputation score of a given digital identity may include, for example, adjustments for an activity score of the digital identity, a value of a transaction conducted by the digital identity, an association with other digital identities, external activities, a trend in the reputation score of the digital identity, etc.

The number of score adjustments may be different for each digital identity. For example, a newly registered digital identity may have interacted with multiple other digital identities but not conducted a transaction. Thus, the reputation score of the newly registered digital identity is not adjusted based on a value of a transaction. The reputation score engine 130 may assign a weight to each score adjustment for a digital identity based on a level of importance of each adjustment to that identity. The machine learning component 140 may learn the importance of each score adjustment based on prior activities of the digital identity.

Once generated, the reputation score engine 130 may store the reputation score for a digital identity in reputation scores 154. Upon storing the reputation score in the data base, the reputation score engine 130 may also update a mapping from the reputation score to a corresponding digital identity in digital identities 152.

When an activity is initiated, the reputation score engine 130 may determine a current reputation score for each digital identity involved in the activity. The reputation score engine 130 may identify a minimum reputation score of the digital identities involved in the activity, and determine whether that reputation score satisfies a low reputation threshold. If the minimum reputation score fails to satisfy the threshold, the reputation score engine 130 may deny the activity from occurring.

If the minimum reputation score satisfies the threshold, the reputation score engine 130 may identify a maximum reputation score of the identities involved in the activity, and determine whether that score satisfies a high reputation threshold. If the maximum reputation score satisfies the high reputation threshold, the reputation score engine 130 may allow the identities involved in the transaction to conduct the activity. If the maximum score does not satisfy the threshold, the reputation score engine 130 may request confirmation from one or more of the identities involved whether to proceed with conducting the activity.

In one embodiment, the low and high reputation thresholds may be static values used for all activities involving digital identities. In another embodiment, each digital identity may be able to set the low and high reputation thresholds to predetermined values. The reputation score engine 130 may use the low and high reputation thresholds to prevent a fraudulent transaction from occurring.

For example, the low reputation threshold may prevent a digital identity with a low reputation score from performing a transaction with a well-established digital identity with a high reputation score. This may prevent a potentially fraudulent transaction by preventing the established identity from providing financial information to the identity with a low reputation score. However, the digital identity associated with the higher reputation score may have the option to proceed in conducting the transaction.

The machine learning component 140 may obtain data related to prior activities, real-time activities, and previously generated reputation scores for registered digital identities. The prior activities of the digital identities may be obtained from identity interactions 156 and identity transactions 158. The previously generated reputation scores for the digital identities may be obtained from reputation scores 154.

The machine learning component 140 may use the obtained data to determine an initial reputation score to assign to a newly created digital identity. For example, the machine learning component 140 may determine an impartial value to assign as an initial reputation score that does not indicate a high reputation score or a low reputation score. The impartial value may be based on a maximum reputation score and a minimum reputation score in reputation scores 154.

The machine learning component 140 may also use the obtained data to determine a value of a transaction. As discussed above, the value of a transaction may be monetary or otherwise. When a transaction is conducted, the machine learning component 140 may determine a value of a current transaction for a given identity involved in the transaction based on prior transactions of that identity.

For example, a recruiting firm may communicate with hundreds of individuals (each corresponding to a digital identity) each day. The goal of the recruiting firm may be to locate individual to fill a vacant position. However, even though a given communication may not lead to filling the position, that communication may lead to filling another position in the future.

Accordingly, the machine learning component 140 may determine that each communication with an individual provides some value to the recruiting firm. Thus, the machine learning component 140 may determine a transaction value of each new communication based on past interactions of the recruiting firm. For example, a response to the communication from the individual may indicate that the communication provides value to the recruiting firm. Similarly, no response from the individual may indicate that the communication does not provide value to the recruiting firm.

In some cases, a content of the response may indicate an amount of value the communication provides to the recruiting firm. Information may be extracted from the response using natural language processing. The extracted information may be used to identify particular content in the response to determine a value provided by the response to the recruiting firm. For example, an affirmative response to the communication may indicate a high value provided to the recruiting firm (i.e., the recipient is likely to use the recruiting firm in the near future), a noncommittal response to the communication may indicate some value that may be provided to the recruiting firm in the future, and a negative response to the communication may indicate that no value would be provided to the recruiting firm.

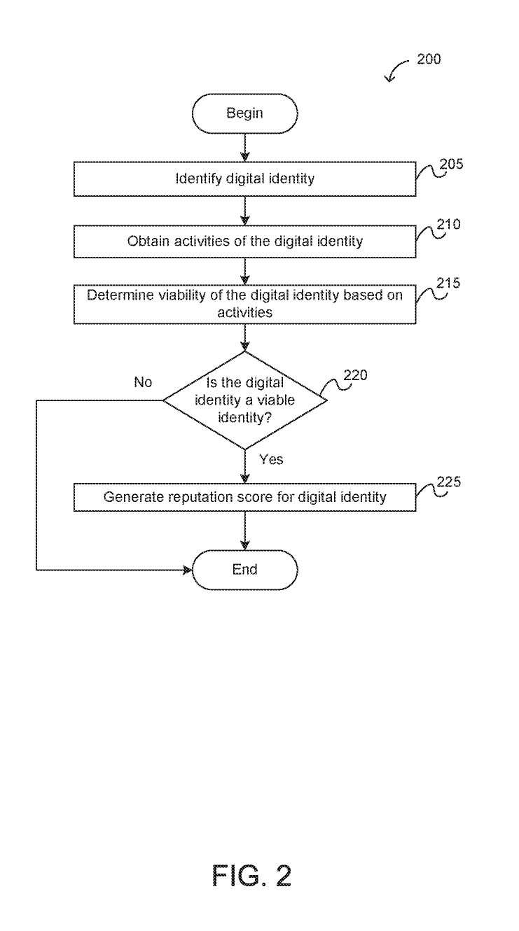

FIG. 2 illustrates a method 200 for determining the validity of a digital identity and whether to generate a reputation score of the digital identity, according to one embodiment. As shown, the method 200 begins at step 205 where a reputation score engine identifies a digital identity. The reputation score engine may obtain information related to the digital identity from a database. The information related to the identity may include, for example, identifying information including a name, address, phone number, and the like.

At step 210, the reputation score engine obtains activities conducted by the digital identity. The activities may include interactions with other digital identities or transactions conducted with the other digital identities. The interactions may include any action taken by the digital identity involving another digital identity. The transactions may include any interaction that provides something of value to the digital identity. The activities may be stored in the database and mapped to a corresponding digital identity.

At step 215, the reputation score engine determines a viability of the digital identity based on the activities obtained in step 210. The viability of a given digital identity may be determined based on an activity score of the digital identity. The activity score may represent a level of activity of the digital identity since a previous update of the reputation score of that digital identity. The activity score may also indicate a level of reliability of the digital identity. For example, a digital identity associated with an entity that has recently interacted with other digital identities is more likely to be an entity that performs any obligations incurred from the interactions.

The reputation score engine 130 may identify a number of other identities associated with an activity conducted by the given identity. The activity score may be determined by normalizing the number of other digital identities by a number of those identities not associated with the given digital identity when the reputation score of the given identity was last determined or updated.

At step 220, the reputation score engine determines whether the digital identity is a viable identity. To do so, the reputation score engine may determine whether the activity score of the digital identity satisfies a viability threshold. In one embodiment, a viability of all digital identities may be determined based on a single viability threshold. In another embodiment, each digital identity may have a specific viability threshold, which changes over time. A machine learning component may determine the viability threshold for a given digital identity based on previous activity scores of that identity. The determination of the viability threshold may also be based, at least in part, on an activity score of one or more other digital identities.

If the activity score of the digital identity does not satisfy the viability threshold, the reputation score engine may terminate the process of generating reputation score for the digital identity. However, upon determining that the activity score of the digital identity satisfies the viability threshold, the reputation score engine generates a reputation score for the digital identity at step 225.

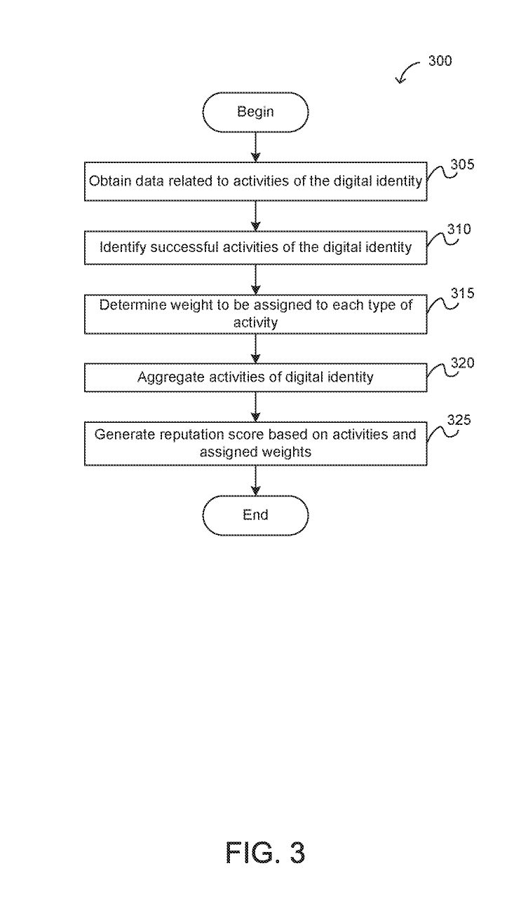

FIG. 3 illustrates a method 300 for determining a reputation score of a digital identity, according to one embodiment. The method 300 begins at step 305 where an activity monitor obtains data related to activities conducted by the digital identity. The activities may include completed and on-going real-time interactions with other digital identities and transactions, as discussed herein. Data related to completed activities may be obtained from a database. The obtained data may include information that identifies each digital identity involved, a reputation score of each digital identity, a type of activity conducted (e.g., an interaction, a transaction), etc. Data related to a transaction may also include a value of the transaction.

The activity monitor may also obtain an external reputation score related to activities of the digital identity. Restrictions enforced by an external entity in possession of data related to external activities of the digital identity may prohibit the activity monitor from obtaining such data. In that case, the activity monitor may obtain a reputation score for the external activities of the digital identity determined by the external entity.

At step 310, a reputation score engine identifies activities of the digital identity. A successful activity may include an interaction may include a transaction conducted between the digital identity and another digital identity. A transaction may be successful if the transaction provides some value, monetary or otherwise, to the digital identity.

At step 315, the reputation score engine determines a weight for each type of activity. The weight for a given type of activity may indicate a level in which that type of activity affects the reputation score for the digital identity. For example, a successful activity conducted by the digital identity may have a larger weight, and thus a greater effect on the reputation score, than an unsuccessful activity. A weight may also be determined for an external reputation score. A machine learning component may provide input for determining the weight for each type of activity. Once determined, the reputation score engine may assign each weight to each corresponding activity.

At step 320, the reputation score engine aggregates all activities of the digital identity. That is, the reputation score engine may combine the interactions and transactions of the digital identity into a single data set. The data set may include prior and real-time activities of the digital identity. The reputation score engine may also include any external reputation score(s) in the aggregated data set.

At step 325, the reputation score engine generates a reputation score of the digital identity based on the aggregated activities and assigned weights. To do so, the reputation score engine may determine whether a reputation score has been previously determined for the digital identity. If not, the reputation score engine may determine an initial reputation score of the digital identity. The initial reputation score may a neutral value that is about half of a difference between a maximum reputation score and a minimum reputation score.

Once the initial reputation score is determined, the reputation score engine may adjust the value of the reputation score by one or more reputation score adjustments, as discussed herein. The score adjustments may be limited to activities of the digital identity that have been conducted since a previous update or determination of the reputation score of that digital identity. The reputation score engine may adjust the initial reputation score based on an activity score of the digital identity, a value of a transaction conducted by the digital identity, an association with other digital identities, external activities, a trend in the reputation score of the digital identity, etc.

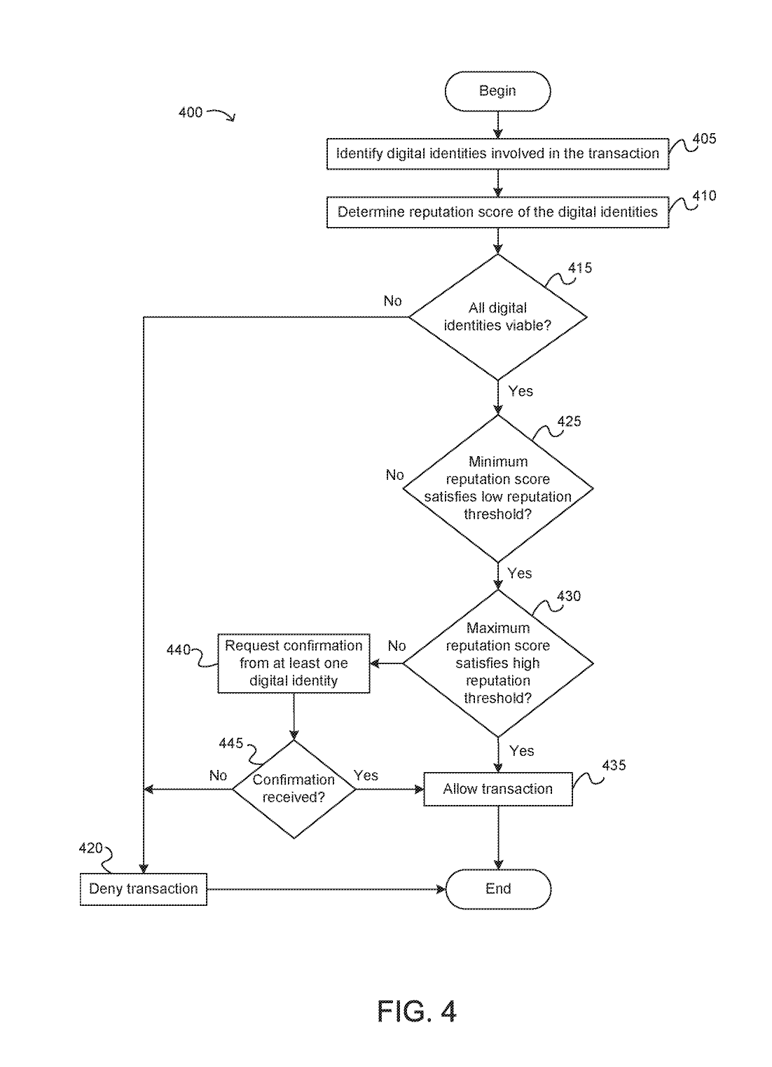

FIG. 4 illustrates a flow diagram 400 illustrating example operations using a dynamic reputation score in processing a transaction, according to one embodiment. While FIG. 4 illustrates operations according to the embodiments disclosed herein, it should be understood that these operations are merely example operations that do not limit the scope of the present disclosure.

As shown, the flow diagram 400 begins at step 405 where a reputation score engine identifies two or more digital identities involved in the transaction. At step 410, the reputation score engine determines a reputation score of each digital identity involved in the transaction. The reputation score engine may obtain the reputation score for one or more of the identities involved from a database. However, for each identity that does not have a reputation score in the database, the reputation score engine may determine a reputation score using method 300 described with reference to FIG. 3.

At step 415, the reputation score engine determines whether all digital identities involved in the transaction are viable identities. An activity score of a given digital identity may be used to determine whether that identity is viable. The activity score may identify a number of activities conducted by the given digital identity since a previous update of the reputation score of that identity. The reputation score engine may determine the activity score of the given identity by dividing a total number of activities of that identity by the number of activities conducted since the previous update of the reputation score. If the activity score of the given digital identity fails to satisfy an activity score threshold, that digital identity is not a viable identity.

If one or more digital identities involved in the transaction is not a viable identity, the reputation score engine denies the transaction at step 420. That is, the reputation score engine may prevent the transaction from proceeding and inform the involved digital identities that the transaction has been terminated. If all digital identities involved are viable, the reputation score engine proceeds to step 425.

At step 425, the reputation score engine determines whether a minimum reputation score of the digital identities involved in the transaction satisfies a low reputation threshold. The minimum reputation score may correspond to the lowest reputation score of all digital identities involved in the transaction. If the minimum reputation score fails to satisfy the low reputation score threshold, the reputation score engine denies the transaction at step 420. If the minimum reputation score satisfies the low reputation threshold, the reputation score engine determines whether a maximum reputation score satisfies a high reputation score threshold at step 430.

The maximum reputation score may correspond to the highest reputation score of the digital entities involved in the transaction. If the maximum reputation score satisfies the high reputation threshold, the reputation score engine allows the transaction at step 435. If the maximum reputation score fails to satisfy the high reputation threshold, the reputation score engine requests confirmation from at least one digital identity involved in the transaction at step 440. The confirmation request may indicate a high level of risk involved in proceeding with the transaction. Confirmation may be requested from one or more digital identities involved in the transaction other than the identity corresponding to the maximum reputation score.

At step 445, the reputation score determines whether confirmation is received. Upon receiving confirmation, the reputation score engine allows the transaction proceed at step 435. If the reputation score engine does not receive confirmation, the transaction is denied at step 420. The reputation score engine may deny the transaction if the one or more entities reject the confirmation request. The reputation score engine may also wait a predetermined period of time before denying the transaction to ensure each identity has time to review the reputation scores of other identities involved in the transaction and make an informed decision on whether to proceed.

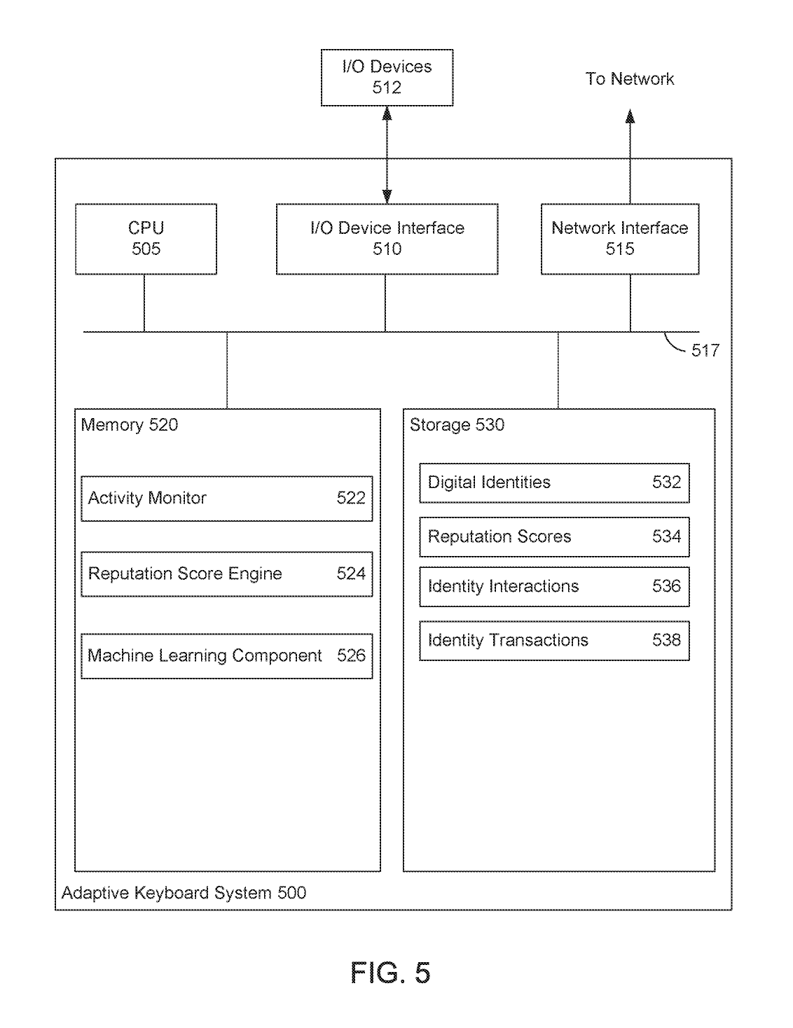

FIG. 5 illustrates an example computing system 500 configured to generate a reputation score of a digital identity, according to one embodiment. As shown, the computing system 500 includes, without limitation, a central processing unit (CPU) 505, a network interface 515, a memory 520, and storage 530, each connected to a bus 517. The computing system 500 may also include an I/O device interface 510 connecting I/O devices 512 (e.g., keyboard, display, mouse devices, image capture devices, etc.) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in the memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of a random access memory. The storage 530 may be a disk drive or flash storage device. Although shown as a single unit, the storage 530 may be a combination of fixed and/or removable storage devices, such as fixed disc drives, removable memory cards, optical storage, network attached storage (NAS), or a storage area-network (SAN).

As shown, storage 530 includes digital identities 532, reputation scores 534, identity interactions 536, and identity transaction 538. Each digital identity in digital identities 532 includes at least an identity of a corresponding entity. A reputation score for each digital identity in digital identities 532 may be stored in reputation scores 534. The storage 530 may also include a mapping between each of the digital identities 532, the reputation scores 534, the identity interactions 536, and the identity transaction 538. The mapping may be used to determine a location of reputation scores, interactions, and transactions involving a given digital identity in digital identities 532.

Illustratively, the memory 520 includes an activity monitor 522, a reputation score engine 524, and a machine learning component 526. In certain aspects, these components may correspond to the components of the server computer described with reference to FIG. 1. For example, a digital identity for one or more entities may be stored in digital identities 532. Each digital identity in digital identities 532 may include information identifying the one or more entities.

The activity monitor 522 may obtain all activities conducted by a given digital identity. The obtained activities may include completed and real-time activities of the given digital identity. The activities may include interactions and transactions of the given digital identity. An interaction may include an action taken by the given digital identity that involves another digital identity. A transaction may include an interaction that involves something of value to the given digital identity. That is, the transaction may involve a value that is monetary or non-monetary.

For each interaction or transaction of the given digital identity, the activity monitor 522 may update the mapping in storage 530. Thus, the mapping may be used to identify a location of one or more interactions or transactions conducted by the given digital identity.

The reputation score engine 524 may determine an initial reputation score for a given digital identity. The initial reputation score may be a neutral value that is substantially half of a difference between a maximum reputation score and a minimum reputation score. The reputation score engine may adjust the reputation score of the digital identity based on prior and real-time activities conducted by the digital identity.

For example, the reputation score of a given digital identity may be adjusted based on an activity score of the digital identity. The activity score may indicate a level of activity of the digital identity since a previous reputation score was determined for the digital identity. To determine an activity score of a given digital identity, the reputation score engine 524 may identify a number of other digital identities associated with an activity conducted by the given digital identity. The reputation score engine 524 may also identify a number of the other digital identities, which were not associated with an activity of the given digital identity when the reputation score of the given identity was last updated. The reputation score engine 524 may normalize the number of other identities by the number of other identities that were not previously associated with an activity of the given identity.

The reputation score of the given digital identity may also be adjusted based on a value of a transaction conducted by that identity. The value of the transaction may be a monetary or non-monetary value. The reputation score engine 524 may normalize the value of the transaction by a weight of the highest value of a transaction performed by any identity to the highest value of a transaction performed by the given digital identity.

The reputation score engine 524 may adjust the reputation score of the given digital identity based on an association with another digital identity with an established reputation score. The reputation score engine 524 may identify a reputation score for each digital identity involved in an activity of the given digital identity. The reputation score of the given identity may be adjusted based on a weighted value of the reputation score of another digital identity involved in the activity.

The weight applied to the reputation score of the other identity may be determined by the machine learning component 526. For example, the machine learning component 526 may determine the weight based on the reputation score of and activities conducted by the other identity. The machine learning component may also determine the weight based on a number of other activities conducted by the given digital identity and reputation scores of other digital identities involved in those activities. The reputation score adjustment based on associations with other identities may be limited to successful transactions between the given identity and at least one other digital identity.

The reputation score engine may adjust the reputation score of the given digital identity based on an external reputation score obtained by the activity monitor 522. For example, the some activities of the digital identity may not be accessible by the activity monitor 522. In that case, the activity monitor 522 may obtain an external activity score for the given identity from an external service. The external service may generate the external reputation score based on the activities of the given identity which cannot be obtained by the activity monitor 522.

The reputation score engine 524 may determine a trend in the reputation score of the given digital identity. The trend may be used to adjust the reputation score of the given identity. For example, the reputation score engine may determine a difference between an historical reputation score and a real-time reputation score for the given digital identity. The real-time reputation score may be determined based on activities conducted by the given identity during the preceding six months. The historical reputation score may be based on activities conducted by the given identity over the preceding twelve months.

The reputation score engine 524 may determine an adjustment to the reputation score of the given digital identity based on a completeness score. The completeness score may be determined by identifying a number of score adjustments that are completed and a number of score adjustments that are not completed. The score adjustments for a given digital identity may include adjustments for an activity score of the given identity, a value of a transaction conducted by the given identity, an association with another digital identity, an external activity score of the given identity, a trend in the reputation score of the given identity, etc.

A total number of score adjustments may be different for each digital identity. For example, a given identity may not have conducted external activities and thus would not have an external reputation score. Thus, the number of adjustments may be at least one less than another digital identity that has conducted external activities and has an external reputation score.

Once the reputation score of the given digital identity is generated and adjusted, the reputation score engine 524 may store the reputation score in reputation scores 534. The reputation score engine may also update a mapping between the digital identities 532 to the reputations scores 534.

The machine learning component 526 may obtain a reputation score, one or more interactions, and one or more transactions of a given digital identity. The machine learning component 526 may use the obtained data to determine a value of a transaction conducted by the given digital identity. For example, the machine learning component 526 may determine a non-monetary value of a transaction based on past transactions conducted by the given identity that were non-monetary transactions.

The machine learning component 526 may also use the obtained data to determine a weight of an association of the given identity with another digital identity. The weight may be based on the reputation scores of the given digital identity and the other digital identity as well as a reputation score of other digital identities involved in prior activities conducted by the given identity. The prior activities of the given identity may be limited to a certain type of activity (e.g., an interaction or a transaction), or activities that occurred within a certain time period.

It may be noted that, descriptions of embodiments of the present disclosure are presented above for purposes of illustration, but embodiments of the present disclosure are not intended to be limited to any of the disclosed embodiments. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments, and advantages are merely illustrative and are not considered elements or limitations of the appended claims except where explicitly recited in a claim(s). Likewise, reference to “the invention” shall not be construed as a generalization of any inventive subject matter disclosed herein and shall not be considered an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “component,” “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions. While the foregoing is directed to embodiments of the present disclosure, other and further embodiments of the disclosure may be devised without departing from the basic scope thereof, and the scope thereof is determined by the claims that follow.

What is claimed is:

1. A computer-implemented method comprising:
identifying at least a first digital identity and a second digital identity involved in an activity from a plurality of digital identities;
obtaining data related to prior activities of the first digital identity;
determining an initial reputation score of the first digital identity based, at least in part, on one or more weighted reputation attributes;
adjusting the initial reputation score of the first digital identity based on prior activities that occurred since a previous update of the reputation score of the first digital identity; and
determining whether to terminate or allow the activity based on the adjusted reputation score of the first digital identity and a reputation score of the second digital identity.

2. The method of claim 1, further comprising:
determining a weight assigned to each reputation attribute based on a level of importance of a corresponding reputation attribute to the reputation score.

3. The method of claim 1, wherein each of the one or more reputation attributes include at least one of:
an activity score of the first digital identity;
a value of a transaction conducted by the first digital identity;
an association of the first digital identity with at least one digital identity from the plurality of digital identities;
an external reputation score;
a trend in the reputation score of the first digital identity; and
a completeness score.

4. The method of claim 3, wherein adjusting the initial reputation score comprises an adjustment for at least one of the one or more reputation attributes.

5. The method of claim 3, wherein an activity score of the first digital identity is based, at least in part, on a number of digital identities from the plurality of digital identities associated with one or more of the prior activities conducted the previous update of the reputation score of the first digital identity.

6. The method of claim 3, wherein an adjustment to the initial reputation score for an association is based, at least in part, on a reputation score of the at least one digital identity from the plurality of digital identities.

7. The method of claim 1, further comprising:
determining a reputation score of the second digital identity;
upon determining that at least one of the reputation score of the first digital identity and the reputation score of the second digital identity fails to satisfy a low reputation threshold and a high reputation threshold, terminating the activity; and
upon determining that at least one of the reputation score of the first digital identity and the reputation score of the second digital identity satisfy a low reputation threshold and a high reputation threshold, allowing the activity.

8. The method of claim 1, further comprising:
determining a viability of each of the first digital identity and the second digital identity;
upon determining either of the first digital identity or the second digital identity is not viable, terminating the activity; and
upon determining both the first digital identity and the second digital identity are viable, allowing the activity.

9. A computer-readable storage medium storing instructions, which, when executed on a processor, perform an operation, the operation comprising:
identifying at least a first digital identity and a second digital identity involved in an activity from a plurality of digital identities;
obtaining data related to prior activities of the first digital identity;
determining an initial reputation score of the first digital identity based, at least in part, on one or more weighted reputation attributes;
adjusting the initial reputation score of the first digital identity based on prior activities that occurred since a previous update of the reputation score of the first digital identity; and
determining whether to terminate or allow the activity based on the adjusted reputation score of the first digital identity and a reputation score of the second digital identity.

10. The computer-readable storage medium of claim 9, the operation further comprising:
determining a weight assigned to each reputation attribute based on a level of importance of a corresponding reputation attribute to the reputation score.

11. The computer-readable storage medium of claim 9, herein each of the one or more reputation attributes include at least one of:
an activity score of the first digital identity;
a value of a transaction conducted by the first digital identity;
an association of the first digital identity with at least one digital identity from the plurality of digital identities;
an external reputation score;
a trend in the reputation score of the first digital identity; and
a completeness score.

12. The computer-readable storage medium of claim 11, wherein adjusting the initial reputation score comprises an adjustment for at least one of the one or more reputation attributes.

13. The computer-readable storage medium of claim 11, wherein an activity score of the first digital identity is based, at least in part, on a number of digital identities from the plurality of digital identities associated with one or more of the prior activities conducted the previous update of the reputation score of the first digital identity.

14. The computer-readable storage medium of claim 11, wherein an adjustment to the initial reputation score for an association is based, at least in part on, a reputation score of the at least one digital identity from the plurality of digital identities.

15. The computer-readable storage medium of claim 9, the operation further comprising:
determining a reputation score of the second digital identity;
upon determining that at least one of the reputation score of the first digital identity and the reputation score of the second digital identity fails to satisfy a low reputation threshold and a high reputation threshold, terminating the activity; and
upon determining that at least one of the reputation score of the first digital identity and the reputation score of the second digital identity satisfy a low reputation threshold and a high reputation threshold, allowing the activity.

16. The computer-readable storage medium of claim 9, the operation further comprising:
determining a viability of each of the first digital identity and the second digital identity;
upon determining either of the first digital identity or the second digital identity is not viable, terminating the activity; and
upon determining both the first digital identity and the second digital identity are viable, allowing the activity.

17. A system, comprising:
a processor; and
a memory hosting an application, which, when executed on the processor, performs an operation, the operation comprising:
identifying at least a first digital identity and a second digital identity involved in an activity from a plurality of digital identities;
obtaining data related to prior activities of the first digital identity;
determining an initial reputation score of the first digital identity based, at least in part, on one or more weighted reputation attributes;
adjusting the initial reputation score of the first digital identity based on prior activities that occurred since a previous update of the reputation score of the first digital identity; and
determining whether to terminate or allow the activity based on the adjusted reputation score of the first digital identity and a reputation score of the second digital identity.

18. The system of claim 17, the operation further comprising:
determining a weight assigned to each reputation attribute based on a level of importance of a corresponding reputation attribute to the reputation score.

19. The system of claim 17, herein each of the one or more reputation attributes include at least one of:
an activity score of the first digital identity;
a value of a transaction conducted by the first digital identity;
an association of the first digital identity with at least one digital identity from the plurality of digital identities;
an external reputation score;
a trend in the reputation score of the first digital identity; and
a completeness score.

20. The system of claim 17, the operation further comprising:
determining a reputation score of the second digital identity;
upon determining that at least one of the reputation score of the first digital identity and the reputation score of the second digital identity fails to satisfy a low reputation threshold and a high reputation threshold, terminating the activity; and
upon determining that at least one of the reputation score of the first digital identity and the reputation score of the second digital identity satisfy a low reputation threshold and a high reputation threshold, allowing the activity.
